(19) United States
(12) Patent Application Publication
(10) Pub. No.: US 2024/0428674 A1
(43) Pub. Date: Dec. 26, 2024

(54) A CARD PACKAGE ACCESSORY WITH AN ANTI-LOST FUNCTION

(71) Applicants: Shaomin WANG, Dongguan (CN); Rongtian MA, Nanning (CN)

(72) Inventors: Shaomin WANG, Dongguan (CN); Rongtian MA, Nanning (CN)

(21) Appl. No.: 18/822,419

(22) Filed: Sep. 2, 2024

(30) Foreign Application Priority Data
Aug. 8, 2024 (CN) 202421918388.9

(51) Int. Cl. G08B 21/24; G08B 3/10; H04W 4/80

(52) U.S. Cl. CPC G08B 21/24; G08B 3/10; H04W 4/80

(57) ABSTRACT

A card package accessory with an anti-lost function is provided. The card package accessory with an anti-lost function includes: a panel, a base plate, and a PCB circuit board, the PCB is located in an internal space formed by the panel and the base plate, and the PCB is located in an internal space formed by the panel and the base plate; and the PCB comprises a controller, Bluetooth positioner, and a buzzer; when the card package accessory is lost, the mobile phone sends a loss signal to the Bluetooth positioner, and the Bluetooth positioner transmits the loss signal to the controller, allow the controller controls the buzzer to emit a buzzing sound for finding. The card package accessory with the anti-lost function, solve the problem of difficulty in finding lost card package accessory, and can be used as a standalone anti loss device.

### CROSS-REFERENCE TO RELATED APPLICATIONS

This application claims foreign priority of Chinese Patent Application No. 202421918388.9, filed on Aug. 8, 2024 in the China National Intellectual Property Administration, the disclosures of all of which are hereby incorporated by reference.

### TECHNICAL FIELD

The present disclosure relates to the technical field of articles for daily use, in particular to a card package accessory with an anti-lost function.

### BACKGROUND

With the rapid development of mobile payment, the carrying of paper money is less and less, and carrying of credit card is very common. So that a compact anti-theft card package appears on the market, which is used for a scene carried by a credit card, and a compact card package is often given as a gift. However, there are three disadvantages in the compact card packages: the appearance is monotonous and difficult to meet the personalized esthetic requirements of consumers; and the card package has a self-weight, and is small in size and easy to fall; and unable to meet customized needs, a prior card package cannot express and display customization requirements of users.

### SUMMARY

The present disclosure provides a card package accessory with an anti-lost function, which is equipped with a find my function and is able to personalized customization, to overcome the disadvantages of the prior card packages.

The present disclosure further provides a card package accessory with an anti-lost function, includes a panel, a base plate, and a printed circuit board (PCB) circuit board; the PCB is located in an internal space formed by the panel and the base plate, and the PCB is located in an internal space formed by the panel and the base plate; and the PCB comprises a controller, Bluetooth positioner, and a buzzer; and the Bluetooth positioner is wirelessly communicated with a mobile phone, and sends positioning information to the mobile phone, and receives information transmitted by the mobile phone; and the buzzer is communicated with the controller; and when the card package accessory is lost, the mobile phone sends a loss signal to the Bluetooth positioner, and the Bluetooth positioner transmits the loss signal to the controller, when the controller receives the loss signal, the controller controls the buzzer to emit a buzzing sound for finding.

Furthermore, the card package accessory with the anti-lost function also includes a Bluetooth positioner switch, and the Bluetooth positioner switch is connected to the Bluetooth positioner to control the switch of the Bluetooth positioner.

Furthermore, the controller is communicated to the Bluetooth positioner switch, and when the Bluetooth positioner switch is turned on or turned off, the Bluetooth positioner switch transmits a turn-on/turn-off signal to the controller, and then the controller sends the turn-on/turn-off signal to the buzzer to control the buzzer to emit a turn-on/turn-off sound.

Furthermore, a switch key is provided on the panel, and the switch key is connected to the Bluetooth positioner switch.

Furthermore, the card package accessory with the anti-lost function further comprises an ink screen, the ink screen is arranged on the panel and connected to the controller, and the ink screen is communicated with the controller; the mobile phone sends picture information to the Bluetooth positioner through an APP, the Bluetooth positioner sends the picture information to the controller, and the controller controls the ink screen to display picture information.

Furthermore, the panel is provided with an antenna outlet, and the antenna outlet is a Bluetooth antenna outlet of the Bluetooth positioner.

Furthermore, the panel is provided with a sound emitting hole, and the sound emitting hole is located above the buzzer to facilitate sound of the buzzer spread in all directions.

Furthermore, the package accessory with the anti-lost function further comprises a plurality of screws, and the plurality of screws are configured to connect the panel and the base plate as a whole.

Furthermore, a shape of the panel is a rectangle with a card pushing notch, and the base plate has a same shape with that of the panel.

Furthermore, the card package accessory with the anti-lost function further comprises a battery, and the battery is connected to the PCB, and the battery is configured to supply power to the PCB.

The card package accessory with the anti-lost function provided by this disclosure, it is easy to replace the appearance of the prior card package accessories. With the function of find my anti-lost, solving the problem of difficulty in finding lost card packs. If the users do not want to replace the cover of their wallet temporarily after purchasing prior card package accessories, the card package accessory with the anti-lost function of the present disclosure can also be used separately as an anti-loss device, such as placing them on luggage as anti drop cards, etc.

### BRIEF DESCRIPTION OF THE DRAWINGS

FIG. 1 is a schematic structural diagram of a card package accessory with a anti-lost function according to an embodiment of the present disclosure.

FIG. 2 is a schematic structural diagram of a card package accessory with the anti-lost function from another perspective according to an embodiment of the present disclosure.

### DETAILED DESCRIPTION OF THE EMBODIMENTS

It should be noted that the following detailed descriptions are exemplary and are intended to provide a further description of the present disclosure. Unless otherwise specified, all technical and scientific terms used herein have the same meaning as commonly understood by one of ordinary skill in the art to which this invention belongs.

It should be noted that the terminology used herein is for the purpose of describing particular embodiments only and is not intended to limit the exemplary embodiments according to the present disclosure. As used herein, the singular forms are intended to include the plural forms as well, unless the context clearly indicates otherwise, and it is also to be understood that when the terms “include” and/or “compose” are used in this specification, they indicate the presence of features, steps, operations, and/or combinations thereof.

The card package accessory with an anti-lost function of the present disclosure includes a panel 10, a base plate 20, and a printed circuit board (PCB) 30. The PCB 30 is located in an internal space formed by the panel 20 and the base plate 10. The card package accessory with the anti-lost function can be placed on the original card package to realize the find my function and the ink screen display function.

The PCB includes a controller 31, Bluetooth positioner 32, a buzzer 33, and a Bluetooth positioner switch 34.

The Bluetooth positioner 32 is wirelessly communicated with a mobile phone 200 through a Bluetooth antenna, and the Bluetooth positioner 32 sends positioning information to the mobile phone 200, and receives information transmitted by the mobile phone 200.

The controller 31 is connected to the Bluetooth positioner 32 and receives the information transmitted by the Bluetooth positioner 32.

The Bluetooth positioner switch 34 is connected to the Bluetooth positioner to control the switch of the Bluetooth positioner 32. The controller 31 is communicated to the Bluetooth positioner switch 34, and receives the the turn-on/turn-off signal from the Bluetooth positioner switch 34.

The buzzer 33 is communicated with the controller 31, and when the card packet is lost, the mobile phone 200 sends a lost signal to the Bluetooth positioner 32, and the Bluetooth positioner 32 transmits the lost signal to the controller 31, and when the controller 31 receives the lost signal, the controller 31 controls the buzzer 33 to emit a buzzing sound for finding. When the Bluetooth positioner 32 is turned on or off, the controller 31 sends a turn-on/turn-off signal to the buzzer 33, and the buzzer 33 emits a turn-on/turn-off sound.

The panel 10 is provided with a lens, the lens is an ink screen 12 connected to the controller 31, the mobile phone 200 sends picture information to the Bluetooth positioner 32 and related circuits, and the Bluetooth positioner 32 and the related circuit send the picture information to the controller 31, and the controller 31 controls the ink screen 12 to display picture information.

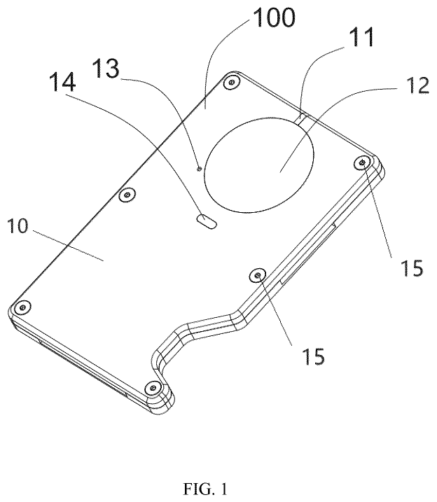

FIG. 1 is a schematic structural diagram of a card package accessory with a anti-lost function according to an embodiment of the present disclosure, shown in a front view. As shown in FIG. 1, the panel 10 includes an antenna outlet 11, a lens or an ink screen 12, and a sound emitting hole 13, and a switch key 14, a plurality of screws 5.

The antenna outlet 11 is an antenna outlet of the Bluetooth positioner. The sound emitting hole 13 is a sound emitting hole of the buzzer. The switch key 14 is a Bluetooth positioner switch. When the switch key 4 is turned on, the Bluetooth positioner starts to work. The plurality of screws 15 are used to connect the panel and the base plate as a whole.

The lens 12 is an ink screen, and may be connected to an APP of the mobile phone, through Bluetooth to realize self-definition of the picture. The ink screen described in the present disclosure is essentially an electronic ink screen, which may display a changed image like a conventional electronic screen. The electronic ink screen is also referred to as an electronic paper display technology, the structure of the paper is composed of two substrates, the paper is coated with electronic ink composed of countless tiny transparent particles, the particles are formed by sealing a plurality of black and white particles with positive and negative electricity in the internal liquid micro capsules, charged particles of different colors can move in different directions due to different applied electric fields, and a black or white effect is presented on the surface of the display screen. In this way, the surface of the “electronic paper” can display the black and white patterns and characters of the printing object, which appear very similar to the paper, and there is no reflection phenomenon of the traditional liquid crystal display in the sunlight. At the same time, only the pixel color changes (for example, from black to white) to consume power, and the picture on the display screen can still be reserved after the power supply is turned off, so that it is very power-saving. A method of displaying an image on an electronic ink screen can be referred to U.S. Ser. No. 17/532,470, color image processing method and device, electronic ink screen, and storage medium.

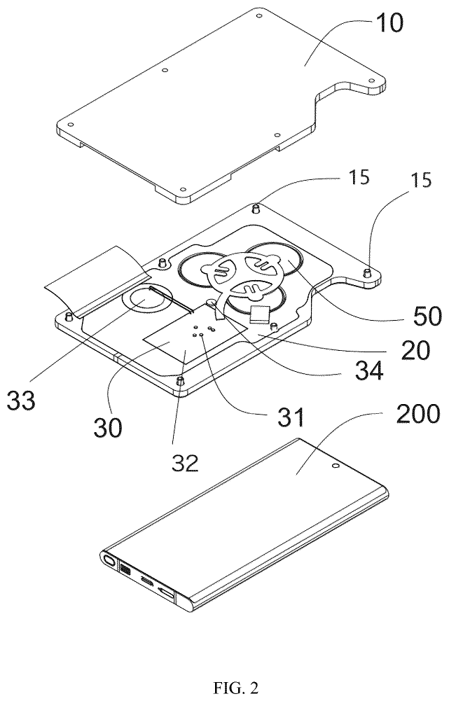

FIG. 2 is a schematic structural diagram of a card package accessory with the anti-lost function from another perspective according to an embodiment of the present disclosure, FIG. 2 is a rear view, as shown in FIG. 2, a circular hardware sheet on the back surface is a battery elastic sheet, and is connected to three batteries 50 and a PCB 30.

The PCB 30 includes a controller 31, Bluetooth positioner 32, and a buzzer 33 and a Bluetooth positioner switch 32.

The Bluetooth positioner 32 is wirelessly communicated with a mobile phone 200 through a Bluetooth antenna, and sends positioning information to the mobile phone 200, and receives information transmitted by the mobile phone 200. The buzzer 33 is communicated with the controller 31, when the card package accessory is lost, the mobile phone 200 sends a loss signal to the Bluetooth positioner 32, and the Bluetooth positioner 32 transmits the loss signal to the controller 31, and when the controller 31 receives the loss signal, the controller 33 controls the buzzer 33 to emit a buzzing sound for finding

The Bluetooth positioner switch 34 is connected to the Bluetooth positioner 32 to control the switch of the Bluetooth positioner 32.

The controller 31 is communicated to the Bluetooth positioner switch 34, and when the Bluetooth positioner switch 34 is turned on or turned off, the Bluetooth positioner switch 34 transmits a turn-on/turn-off signal to the controller 31, and then the controller 31 sends the turn-on/turn-off signal to the buzzer 33 to control the buzzer 33 to emit a turn-on/turn-off sound.

The mobile phone 200 sends picture information to the Bluetooth positioner 32 through an APP, the Bluetooth positioner 32 sends the picture information to the controller 31, and the controller 31 controls the ink screen 12 to display the picture information.

A shape of the panel 10 is a rectangle with a card pushing notch, and the base plate has a same shape with that of the pane.

The battery 50 is connected to the PCB 30, and the battery 50 is configured to supply power to the PCB 30.

Finally, it should be noted that the above are only preferred embodiments of the present disclosure and are not intended to limit the present disclosure, although the present disclosure is described in detail with reference to the foregoing embodiments, for a person skilled in the art, the technical solutions described in the foregoing embodiments may still be modified, or some of the technical features may be equivalently replaced. Any modification, equivalent replacement, or improvement made within the spirit and principle of the present disclosure shall fall within the protection scope of the present disclosure.

The above are only some embodiments of the present disclosure, and neither the words nor the drawings can limit the protection scope of the present disclosure. Any equivalent structural transformation made by using the contents of the specification and the drawings of the present disclosure under the overall concept of the present disclosure, or directly/indirectly applied in other related technical fields are included in the protection scope of the present disclosure.

What is claimed is:

1. A card package accessory with an anti-lost function, wherein the card package accessory with anti-lost function comprises a panel, a base plate, and a printed circuit board (PCB) circuit board;
the PCB is located in an internal space formed by the panel and the base plate, and the PCB is located in an internal space formed by the panel and the base plate; and
the PCB comprises a controller, Bluetooth positioner, and a buzzer; and
the Bluetooth positioner is wirelessly communicated with a mobile phone, and sends positioning information to the mobile phone, and receives information transmitted by the mobile phone; and
the buzzer is communicated with the controller; and
when the card package accessory is lost, the mobile phone sends a loss signal to the Bluetooth positioner, and the Bluetooth positioner transmits the loss signal to the controller, and when the controller receives the loss signal, the controller controls the buzzer to emit a buzzing sound for finding.

2. The card package accessory with the anti-lost function according to claim 1, wherein the card package accessory with the anti-lost function further comprises a Bluetooth positioner switch, and the Bluetooth positioner switch is connected to the Bluetooth positioner to control the switch of the Bluetooth positioner.

3. The card package accessory with the anti-lost function according to claim 2, wherein the controller is communicated to the Bluetooth positioner switch, and when the Bluetooth positioner switch is turned on or turned off, the Bluetooth positioner switch transmits a turn-on/turn-off signal to the controller, and then the controller sends the turn-on/turn-off signal to the buzzer to control the buzzer to emit a turn-on/turn-off sound.

4. The card package accessory with the anti-lost function according to claim 2, wherein a switch key is provided on the panel, and the switch key is connected to the Bluetooth positioner switch.

5. The card package accessory with the anti-lost function according to claim 1, wherein the card package accessory with the anti-lost function further comprises an ink screen, the ink screen is arranged on the panel and connected to the controller, and the ink screen is communicated with the controller;
the mobile phone sends picture information to the Bluetooth positioner through an APP, the Bluetooth positioner sends the picture information to the controller, and the controller controls the ink screen to display the picture information.

6. The card package accessory with the anti-lost function according to claim 1, wherein the panel is provided with an antenna outlet, and the antenna outlet is a Bluetooth antenna outlet of the Bluetooth positioner.

7. The card package accessory with the anti-lost function according to claim 1, wherein the panel is provided with a sound emitting hole, and the sound emitting hole is located above the buzzer to facilitate sound of the buzzer spread in all directions.

8. The package accessory with the anti-lost function according to claim 1, wherein the package accessory with the anti-lost function further comprises a plurality of screws, and the plurality of screws are configured to connect the panel and the base plate as a whole.

9. The card package accessory with the anti-lost function according to claim 1, wherein a shape of the panel is a rectangle with a card pushing notch, and the base plate has a same shape with that of the panel.

10. The card package accessory with the anti-lost function according to claim 1, wherein the card package accessory with the anti-lost function further comprises a battery, and the battery is connected to the PCB, and the battery is configured to supply power to the PCB.
